(19) United States
(12) Patent Application Publication
(10) Pub. No.: US 2014/0274210 A1
(43) Pub. Date: Sep. 18, 2014

(54) DUAL SIM CARD ADAPTER FOR MOBILE DEVICE

(71) Applicant: Eternal Electronics Limited, Tsuen Wan (HK)

(72) Inventors: Hwai Sian Tsai, Tsuen Wan (HK); Suk Kuen Wong, Tsuen Wan (HK)

(73) Assignee: Eternal Electronics Limited, Tsuen Wan (HK)

(21) Appl. No.: 14/210,894

(22) Filed: Mar. 14, 2014

Related U.S. Application Data
(60) Provisional application No. 61/781,798, filed on Mar. 14, 2013.

(51) Int. Cl. H04B 1/38; H04M 1/02

(52) U.S. Cl. CPC H04B 1/3816; H04M 1/0277
USPC 455/558

(57) ABSTRACT

What is disclosed is an apparatus for a dual Subscriber Identity Module (SIM) card adapter, comprising: a first storage space for a SIM card tray ejection pin configured to eject a SIM card from the mobile device; a second storage space for a SIM card tray for a mobile device; a connector operational to be entered into a SIM card slot for the mobile device, said connector comprising an input and an output; a switch comprising an input and at least two outputs, said switch operational to couple the switch input to a selected one of the at least two switch outputs; and at least two integrated SIM card holders.

### CROSS REFERENCE TO RELATED APPLICATION

This application claims the benefit of U.S. Provisional Patent Application No. 61/781,798, filed Mar. 14, 2013, entitled “Dual Sim Card Adapter for Mobile Device” which is hereby incorporated by reference in its entirety.

### FIELD OF THE INVENTION

The present disclosure relates to dual SIM card adapters for mobile devices.

### BRIEF SUMMARY

An apparatus for a dual Subscriber Identity Module (SIM) card adapter, comprising: a first storage space for a SIM card tray ejection pin configured to eject a SIM card from the mobile device; a second storage space for a SIM card tray for a mobile device; a connector operational to be entered into a SIM card slot for the mobile device, said connector comprising an input and an output; a switch comprising an input and at least two outputs, said switch operational to couple the switch input to a selected one of the at least two switch outputs; and at least two integrated SIM card holders.

An apparatus for a dual Subscriber Identity Module (SIM) card adapter comprising a connector operational to be entered into a SIM card slot for a mobile device, said connector comprising an input and an output, wherein the connector input is coupled to the mobile device, and comprises a first plurality of connection pins, the connector output comprises a second plurality of connection pins, and wherein respective ones of said plurality of connection pins of said connector input are communicatively coupled to a corresponding connection pin of said plurality of connection pins of said connector output; a switch comprising an input and at least two outputs, the switch input comprising a plurality of connection pins, each of the at least two switch outputs comprising a plurality of connection pins, and said switch operational to couple the switch input to a selected switch output, wherein respective ones of said plurality of connection pins of said switch input are coupled to a corresponding connection pin of said plurality of connection pins of said selected switch output; at least two integrated SIM card holders, each of the at least two integrated SIM card holders comprising a plurality of connection pins; and wherein said switch input is coupled to said connector output, such that respective ones of said plurality of connection pins of said switch input are coupled to a corresponding connection pin of said plurality of connection pins of said connector output, each of said at least two switch outputs is coupled to a corresponding integrated SIM card holder, each connection pin of said plurality of connection pins of said switch output being coupled to a corresponding connection pin of said plurality of connection pins of said integrated SIM card holder, to form a signal communication path starting at the connector input and ending at a selected one of the at least two integrated SIM card holders that is coupled to the selected switch output, so that signals can travel bidirectionally between the selected one of the at least two integrated SIM card holder and the mobile device.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 shows a dual Subscriber Identity Module (SIM) card adapter 100.

FIG. 2 shows the dual SIM card adapter where the integrated SIM card holders are perpendicular to each other, and each integrated SIM card holder contains a rotatable part to enable easy sliding in of SIM cards.

FIG. 3 shows one view of an embodiment of dual SIM card adapter 100 integrated into a protective case 120 for an APPLE® IPHONE® 5 mobile device 130.

FIG. 4 shows another view of an embodiment of dual SIM card adapter 100 integrated into a protective case 120 for an APPLE® IPHONE® 5 mobile device 130.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

FIG. 1 shows a dual Subscriber Identity Module (SIM) card adapter 100 for a mobile device. The mobile device can be a mobile phone, such as, for example, an APPLE® IPHONE® 4 or 4S or 5; or any mobile device containing a slot for a SIM card. In one embodiment, the dual SIM card adapter comprises a first storage space 101 for a SIM card tray ejection pin, such as that found in an APPLE® IPHONE® 4 or 4S or 5. In another embodiment, the dual SIM card adapter comprises a second storage space 102 for a SIM card tray, such as that used for an APPLE® IPHONE® 4 or 4S or 5. This differs from existing products which do not have these storage spaces. Therefore, the ejection pin and the SIM tray may easily get lost.

The dual SIM card adapter 100 further comprises a connector 105. Connector 105 comprises an input 105-IN and an output 105-OP. Input 105-IN further comprises a plurality of connection pins 105-IN-A to 105-IN-E. Output 105-OP further comprises a plurality of connection pins 105-OP-A to 105-OP-E. Each of 105-IN-A to 105-IN-E is coupled to a corresponding connection pin 105-OP-A to 105-OP-E, for example 105-IN-A is coupled to 105-OP-A; 105-IN-B to 105-OP-B and so on. The connector is operational to be entered into a SIM card slot such as that found in an APPLE® IPHONE® 4 or 4S or 5 to accommodate a SIM card tray. In one embodiment, the connector is a rigid contact. A user can remove the SIM card tray and insert the connector into the SIM card slot, such that signals from the mobile phone which would normally enter a SIM card placed in the SIM card slot are directed into 105-IN, and leave the connector via 105-OP. Similarly signals from the dual SIM card adapter enter the connector via 105-OP and leave the connector to enter the mobile phone via 105-IN. In one embodiment, connections 105-IN-A to 105-IN-E carry signals V_{DD}, GROUND, DATA, CLOCK and RESET signals respectively. These are signals which are typically used by SIM cards to communicate with a mobile device.

The dual SIM card adapter 100 further comprises a switch 103. In one embodiment, switch 103 comprises an input and at least two outputs. For the purposes of this specification, the terms “input” and “output” are used to differentiate the different throws of the switch 103, as data can enter or leave the switch 103 via either the input or one of the outputs. FIG. 1 shows an embodiment of switch 103 with one input 103-IN and 2 outputs 103-OP-1 and 103-OP-2. Input 103-IN further comprises a plurality of connection pins 103-IN-A to 103-IN-E. Each of 103-IN-A to 103-IN-E is coupled to a corresponding connector output 105-OP connection pin 105-OP-A to 105-OP-E by the set of interconnects 100-IC-1. Each output 103-OP-1 and 103-OP-2 comprises a corresponding plurality of connection pins 103-OP-1-A to 103-OP-1-E, and 103-OP-2-A to 103-OP-2-E. The switch can be used to select one of the outputs 103-OP-1 or 103-OP-2 using techniques known to those of skill in the art. In one embodiment, the selection is carried out mechanically. In another embodiment, the selection is carried out electronically. Once a selection is made, signals entering the switch at input 103-IN will leave the selected output, with each of the plurality of input connections connected to a corresponding connection at the output. This is achieved by, for example, using a multiple pole switch. For example, if the selected output is 103-OP-1, then signals entering at 103-IN-A will depart at 103-OP-1-A. Signals entering at 103-IN-B will depart at 103-OP-1-B, and so on. Similarly, signals entering the switch from 103-OP-1 will depart the switch from 103-IN and travel via the connector to the mobile phone, through 105-OP and 105-IN.

Each of the switch outputs are connected to integrated SIM card holders by one or more sets of interconnects. Referring to FIG. 1, 103-OP-1 and 103-OP-2 are connected to integrated SIM card holders 104 and 106 by the set of interconnects 100-IC-2 and the set of interconnects 100-IC-3 respectively. Each integrated SIM card holder comprises a plurality of connection pins. For example, integrated SIM card holder 104 comprises a plurality of connection pins 104-CN, where 104-CN contains connection pins 104A to 104E. Then 104A is coupled to 103-OP-1-A, 104B is coupled to 103-OP-1-B, and so on. In one embodiment, the integrated SIM card holders are designed to either hold SIM cards on their own, or by using appropriate adapters.

Then, when an appropriate selection of an output is made by the switch, a communication path for signals, from an integrated SIM card holder 104, 106 connected to the selected switch output; through the switch input and the connector output and finally to the connector input to enter the mobile device, is created. Signals can travel from the integrated SIM card holder 104, 106 to the mobile device and vice versa. For example, in the embodiment where connection pins 105-IN-A to 105-IN-E carry signals V_{DD}, GROUND, DATA, CLOCK and RESET signals respectively, and 103-OP-1 is selected by switch 103, then 104A to 104E will also carry these signals. In one embodiment, the connections at each switch output corresponding to the GROUND signal are shorted together with the switch input connection pin corresponding to the GROUND signal. For example, if 103-OP-1-B, 103-OP-2-B and 103-IN-B correspond to the GROUND signal, these are shorted together.

In one embodiment, dual SIM card adapter 100 is designed as part of or integrated into a protective case for the mobile device, such as an APPLE® IPHONE® 4 or 4S or 5. Then, the connector is a rigid contact, and is part of the protective case. The protective case can then be easily slid over the mobile device. In this embodiment, the SIM cards or SIM cards with adapters, when inserted into the integrated SIM card holders 104, 106 lie in the same plane that is parallel with a major flat surface (e.g., a video display) of the mobile device. This differs from existing products which use flexible circuit printed boards (FPCB) to make the connection between the mobile phone and the SIM cards. Such products can be difficult for a user to install, and the connectors can be easily damaged.

In another embodiment, the protective case comprises an upper portion and a lower portion, which can be detached from each other. The upper portion can be slid from the top of the mobile device, the lower portion can be slid from the bottom of the mobile device and two portions can be joined together in the middle.

In another embodiment, the protective case comprises a protective rubber coating which can be used to hold the adapter together with the mobile device as well as protect the adapter and the mobile device in case they are dropped. In another embodiment, dual SIM card adapter 100 is a separate unit that a user can carry around and plug into the mobile device whenever a need arises to use a different SIM card.

In another embodiment, the integrated SIM card holders 104, 106 are aligned perpendicularly to each other as shown in FIG. 2. Integrated SIM card holders 104 and 106 comprise movable securing parts 104F and 106F, which can rotate until a final angular position. Then, the user can easily slide in a SIM card such as SIM card 110, or a SIM card within an adapter into the securing part 104F.

FIGS. 3 and 4 shows another embodiment of dual SIM card adapter 100 integrated into a protective case 120 for an APPLE® IPHONE® 5 mobile device 130. Referring to FIG. 4, as mentioned previously, in this embodiment, storage space 101 is designed to hold a SIM card tray ejection pin. Storage space 102 is designed to hold a SIM card tray. As can be seen in FIG. 3, it is shaped so as to securely hold the SIM card tray ejection pin.

As can be seen in FIG. 3 connector 105 is a rigid contact which is positioned to be entered into the SIM card slot 131 of an APPLE® IPHONE® 5 mobile device 130. In this embodiment, the interconnects 100-IC-1, 100-IC-2 and 100-IC-3 of FIG. 1 are integrated within protective case 120. Switch 103 is not visible as it is also integrated within protective case 120.

Integrated SIM card holders 104 and 106 are aligned perpendicularly to each other and contain securing parts 104F and 106F respectively, similar to that shown in FIG. 2. Protective case 120 also comprises protective rubber coating 140 to hold the adapter together with the mobile device 130 and protect the adapter 100 and mobile device 130 in case they are dropped.

In another embodiment, dual SIM card adapter 100 is designed to have space to hold multiple Secure Digital (SD) cards. With the advent of Universal Serial Bus (USB) On the Go (OTG) technology, mobile devices can now be connected to USB flash memory, such that the mobile device is the USB host, and the flash memory device becomes the slave. In a further embodiment, the dual SIM card adapter 100 is designed to hold USB flash memory devices. In yet another embodiment, the dual SIM card adapter 100 is designed to have space to hold one or more batteries connected to the mobile device. In yet another embodiment, the dual SIM card adapter 100 is designed to hold mini energy harvesting systems such as micro scale piezoelectric energy harvesters, similar to the one described in “MEMS power generator with transverse mode thin film PZT” by Jeon, Y. B., R. Sood, J H. Jeong, and S G. Kim, in Sensors and Actuators A: Physical 122, no. 1 (2005): 16-22. Such mini energy harvesting systems can be interconnected to the mobile phone battery so as to “trickle charge” the battery.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. An apparatus for a dual Subscriber Identity Module (SIM) card adapter, comprising:
a first storage space for a SIM card tray ejection pin configured to eject a SIM card from the mobile device;
a second storage space for a SIM card tray for a mobile device;
a connector operational to be entered into a SIM card slot for the mobile device,
said connector comprising an input and an output;
a switch comprising an input and at least two outputs,
said switch operational to couple the switch input to a selected one of the at least two switch outputs; and
at least two integrated SIM card holders.

2. The adapter of claim 1, wherein said switch output is selected mechanically.

3. The adapter of claim 1, wherein each of said at least two integrated SIM card holders holds either a SIM card on its own, or a SIM card within an appropriate adapter.

4. The adapter of claim 1, wherein said switch output is selected electronically.

5. The adapter of claim 1, wherein the mobile device is one of an Apple iPhone 4 mobile device, Apple iPhone 4S and Apple iPhone 5 mobile device.

6. The adapter of claim 5, wherein the adapter is included within a protective case for one of said Apple iPhone 4 mobile device, Apple iPhone 4S and Apple iPhone 5 mobile device.

7. The adapter of claim 1, wherein the adapter is included within a protective case for said mobile device, and wherein said at least two integrated SIM card holders lie in the same plane that is parallel with a major flat surface of the mobile device when the protective case is installed on the mobile device.

8. The adapter of claim 7, wherein said protective case is detachable into an upper portion and a lower portion, and said upper portion and lower portion can be slid over said mobile device and joined in the middle.

9. The adapter of claim 1, wherein the connector is a rigid contact.

10. The adapter of claim 6, wherein the connector is a rigid contact.

11. The adapter of claim 7, wherein the connector is a rigid contact.

12. The adapter of claim 6, wherein
a first set of interconnects is used to couple said switch input to said connector output;
each of said at least two switch outputs is coupled to an integrated SIM card holder by a corresponding set of interconnects, each corresponding set of interconnects being different from the first set of interconnects; and
said sets of interconnects are integrated within the protective case.

13. The adapter of claim 7, wherein
a first set of interconnects is used to couple said switch input to said connector output;
each of said at least two switch outputs is coupled to an integrated SIM card holder by a corresponding set of interconnects, each corresponding set of interconnects being different from the first set of interconnects; and
said sets of interconnects are integrated within the protective case.

14. An apparatus for a dual Subscriber Identity Module (SIM) card adapter comprising:
a connector operational to be entered into a SIM card slot for a mobile device,
said connector comprising an input and an output,
wherein the connector input is coupled to the mobile device, and comprises a first plurality of connection pins,
the connector output comprises a second plurality of connection pins, and
wherein respective ones of said plurality of connection pins of said connector input are communicatively coupled to a corresponding connection pin of said plurality of connection pins of said connector output;
a switch comprising an input and at least two outputs,
the switch input comprising a plurality of connection pins,
each of the at least two switch outputs comprising a plurality of connection pins, and
said switch operational to couple the switch input to a selected switch output,
wherein respective ones of said plurality of connection pins of said switch input are coupled to a corresponding connection pin of said plurality of connection pins of said selected switch output;
at least two integrated SIM card holders,
each of the at least two integrated SIM card holders comprising a plurality of connection pins; and
wherein
said switch input is coupled to said connector output, such that respective ones of said plurality of connection pins of said switch input are coupled to a corresponding connection pin of said plurality of connection pins of said connector output,
each of said at least two switch outputs is coupled to a corresponding integrated SIM card holder, each connection pin of said plurality of connection pins of said switch output being coupled to a corresponding connection pin of said plurality of connection pins of said integrated SIM card holder,
to form a signal communication path starting at the connector input and ending at a selected one of the at least two integrated SIM card holders that is coupled to the selected switch output, so that signals can travel bidirectionally between the selected one of the at least two integrated SIM card holder and the mobile device.

15. The adapter of claim 14 wherein the mobile device is one of an APPLE IPHONE 4 mobile device, APPLE IPHONE 4S and APPLE IPHONE 5 mobile device.

16. The adapter of claim 15, wherein the adapter is included within a protective case for one of said APPLE IPHONE 4 mobile device, APPLE IPHONE 4S and APPLE IPHONE 5 mobile device.

17. The adapter of claim 14, wherein the adapter is included within a protective case for said mobile device, and wherein said at least two integrated SIM card holders lie in the same plane that is parallel with a major flat surface of the mobile device when the protective case is installed on the mobile device.

18. The adapter of claim 17, wherein said protective case is detachable into an upper portion and a lower portion, and said upper portion and lower portion can be slid over said mobile device and joined in the middle.

19. The adapter of claim 14, wherein each of said at least two integrated SIM card holders holds either a SIM card on its own, or a SIM card within an appropriate adapter.

20. The adapter of claim 17, wherein
a first set of interconnects is used to couple said switch input to said connector output;
each of said at least two switch outputs is coupled to an integrated SIM card holder by a corresponding set of interconnects, each corresponding set of interconnects being different from the first set of interconnects; and
said sets of interconnects are integrated within the protective case.
